(19) United States
(12) Patent Application Publication
(10) Pub. No.: US 2024/0025167 A1
(43) Pub. Date: Jan. 25, 2024

(54) Methods To Directly Join Metals To Polymer/Polymer Composites Using Functionally Active Insert Layer

(71) Applicant: THE REGENTS OF THE UNIVERSITY OF MICHIGAN, Ann Arbor, MI (US)

(72) Inventors: Abdul Sayeed KHAN, Ann Arbor, MI (US); Pingsha DONG, Ann Arbor, MI (US); Fengchao LIU, Ann Arbor, MI (US)

(21) Appl. No.: 18/223,311

(22) Filed: Jul. 18, 2023

Related U.S. Application Data
(60) Provisional application No. 63/391,030, filed on Jul. 21, 2022.

(51) Int. Cl. B32B 37/04; B32B 37/10; B32B 37/06; B32B 38/16; B32B 15/08

(52) U.S. Cl. CPC B32B 37/04; B32B 37/10; B32B 37/06; B32B 38/162; B32B 15/08

(57) ABSTRACT

A method of joining a metal part and a polymer/polymer composite part comprising providing a metal part; providing a polymer or polymer composite part; inserting an insert layer between the metal part and the polymer or polymer composite part; and applying heat to the metal part to a temperature above the melting temperatures and below a degradation temperature of the polymer or polymer composite part and the insert layer and simultaneously applying pressure to the combination of the metal part, the polymer or polymer composite part, and the insert layer to combine the metal part and the polymer or polymer composite part into a joined assembly having a chemical bond therebetween.

### CROSS-REFERENCE TO RELATED APPLICATIONS

This application claims the benefit of U.S. Provisional Application No. 63/391,030 filed on Jul. 21, 2022. The entire disclosure of the above application is incorporated herein by reference.

### FIELD

The present disclosure relates to joining materials and, more particularly, relates to methods of directly joining metals to polymer and/or polymer composites using a functionally active insert layer.

### SUMMARY

This section provides a general summary of the disclosure, and is not a comprehensive disclosure of its full scope or all of its features.

According to the principles of the present teachings, methods are provided for direct joining of polymer or polymer composites with metals using an insert layer of functionally active polymer under various heating and pressure applicant mechanisms on the metal side without any kind of surface or material pre-treatment or medication either on metal or polymer/polymer composite sides. In general, polyolefin polymers are hard to bond with any known metal primarily due to its non-polar characteristics. Specifically, these methods successfully demonstrate the joining of polyolefin-polymers or polyolefin-polymer-composites with bare and e-coated metals with significant joint strength using a functionally active insert layer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of the present teachings according to some embodiments illustrating joining of metal or metal alloy to polymer and/or polymer composite.

FIG. 2 is a schematic view of a system of the present teachings according to some embodiments for joining a metal or metal alloy to polymer and/or polymer composite.

FIG. 3 is a schematic view of a system of the present teachings according to some embodiments illustrating joining of coated/uncoated ferrous/non-ferrous metal to a polymer composite.

FIG. 4 is a schematic view of a system of the present teachings according to some embodiments illustrating joining of e-coated metal to a polymer and/or polymer composite.

FIG. 5 is a schematic view of a system of the present teachings according to some embodiments illustrating joining an uncoated metal to a polymer.

FIG. 6 is a schematic view of a system of the present teachings according to some embodiments illustrating joining an uncoated metal to a polymer composite.

FIG. 7 is a schematic view of a system of the present teachings according to some embodiments illustrating joining a coated metal to a polymer and/or polymer composite.

FIG. 8 is a schematic view of a system of the present teachings according to some embodiments illustrating joining a metal to a polymer and/or polymer composite during an extrusion process.

FIG. 9 is a schematic view of a system of the present teachings according to some embodiments illustrating joining a metal to a polymer and/or polymer composite during an injection molding process.

FIG. 10 is a schematic view of a system of the present teachings according to some embodiments illustrating joining a metal to a polymer and/or polymer composite during an injection compression molding process.

FIG. 11 is a schematic view of a system of the present teachings according to some embodiments illustrating joining a metal to a polymer and/or polymer composite during an additive (3D-printing) molding process.

FIG. 12 is a schematic view of a system of the present teachings according to some embodiments illustrating a heat flow process and melt and flow mechanism.

FIG. 13 illustrates experimental proofs relating to uncoated metal and polymer composite according to the present teachings.

FIG. 14 illustrates experimental proofs relating to uncoated metal and polymer composite according to the present teachings.

FIG. 15 illustrates experimental proofs relating to coated metal and polymer composite according to the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

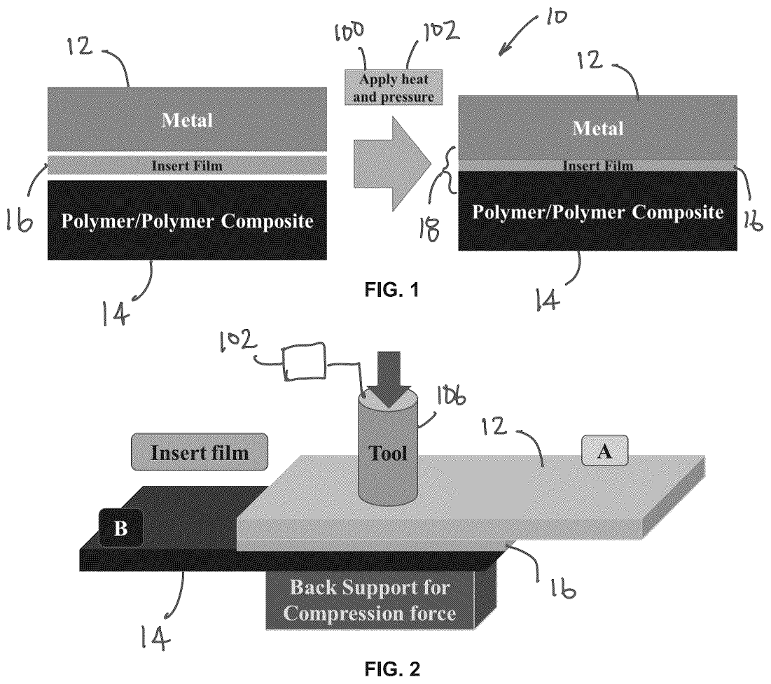

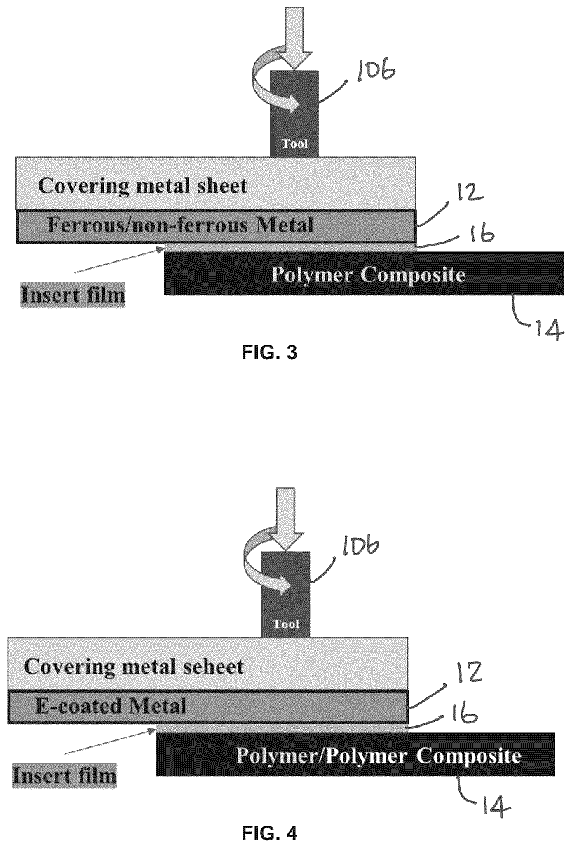

According to the principles of the present teachings, a method and product made by the presented process are provided having advantageous steps and construction in connection with joining an uncoated and/or coated metal to a polymer and/or polymer composite using a functionally active thin film insert layer. That is, in some embodiments as illustrated schematically in FIG. 1, the present teachings provide a joining method 10 wherein a metal part 12 is joined to a polymer and/or polymer composite part 14 via an insert film 16 using applied heat 100 and pressure 102 to produce a joint 18 developed between the metal part 12 and the polymer/polymer composite part 14 using insert film 16.

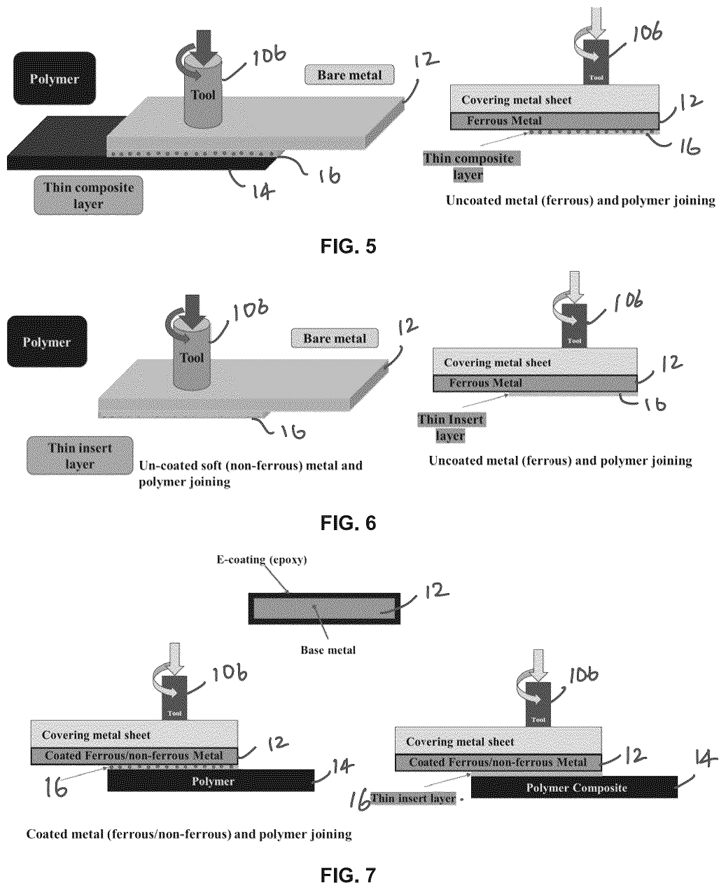

In some embodiments, metal part 12 can comprise a coated and/or uncoated metal (see FIGS. 5-7). That is, in some embodiments, metal part 12 can comprise a surface treatment and/or modification, such as but not limited to any form such as physical, chemical, thermal, laser, optical, electrochemical, electromagnetic, and/or a combination thereof. It should be understood that the surface of metal part 12 can be cleaned using any chemical solvent. For example, at least the joining surface can be degreased using a non-caustic chemical without changing the surface roughness of the joining surface of the metal part. In some embodiments, the non-caustic chemical is ethanol, acetone, or any surface degreasing non-caustic agent. However, it should also be understood that in some embodiments surface cleaning of the metal part 12 may not be necessary or desired. It should also be understood that a coating (see at least FIG. 7) can comprise, but is not limited to, any kind of e-coating, galvanic coating, corrosion resistance (or atmospheric protection) coating or anything as such including compatible or incompatible adhesive coating. In some embodiments, the metal surface has a roughness less than Ra 0.76 microns (μm).

In some embodiments, metal part 12 can comprise any type (see FIGS. 5-7), such as but not limited to pure metal, ferrous or non-ferrous metal, metal alloy of any kind, treated (including, but not limited to, any kind of physical, chemical or metallurgical treatment) or untreated. Moreover, in some embodiments, metal part 12 can be provided in any shape, size, or form and for any kind of application.

In some embodiments, polymer and/or polymer composite part 14 can have any kind of resin (specifically polyolefin thermoplastic, but not limited to) and can be from any category of polymers such as, but not limited to, natural and/or synthetic. In embodiments having polymer composite part 14, the fibers in the polymer composite can be of any form, such as but not limited to any kind and/or form, glass fiber, carbon fiber, aramid fiber, short, long, continuous, spherical fibers, and any other fiber or combination thereof. In some embodiments, polymer and/or polymer composite part 14 can be in any form, such as sheet, block, tube, pipe, or any other geometry of any size or thickness. In some embodiments, polymer and/or polymer composite part 14 can be in the form of elastomers (natural or synthetic rubber or pre/post-forms of rubber materials), such as but not limited to, latex, natural rubber, EPDM (ethylene propylene diene monomer) or a combination/blend of two or multiple polymers or any such forms as well. In some embodiments, polymer and/or polymer composite part 14 can comprise polyolefin polymers, such as those produced from very simple olefin monomers, which do not have any functional groups in the chemical structure. In some embodiments, polymer and/or polymer composite part 14 can comprise thermoplastic polyolefins, such as but not limited to Polypropyelene [PP (including hompolymer and/or copolymer)], low-density polyethylene (LDPE), linear low-density polyethylene (LLDPE), very-low-density polyethylene (VLDPE), ultra-low-density polyethylene (ULDPE), medium-density polyethylene (MDPE), polymethylpentene (PMP), polybutene-1 (PB-1), ethylene-octene copolymers, stereo-block PP, olefin block copolymers, propylene-butane copolymers, polyolefin elastomers, polyisobutylene (PIB), poly(a-olefin)s, ethylene propylene rubber (EPR), and ethylene propylene diene monomer (M-class) rubber (EPDM rubber) and combinations thereof.

In some embodiments, insert film layer 16 can comprise a thin film or layer that can be of any kind of functional polymer or polar polymers (i.e., functionally active) such as but not limited to nylon (or polyamide PA, PA6, PA66, PA12 etc.), polyester (PET), polylactic acid (PLA), acrylonitrile butadiene styrene (ABS), polycarbonate (PC), polyimide (PI), polyaryletherketone (PAEK), Polyether ether ketone (PEEK), syndiotactic polystyrene (SPS), polyphthalamide (PPA), Polybutylene terephthalate (PBT), Polyoxymethylene (POM), polyamide-imide (PAI), poly methyl methacrylate (PMMA), polyphenylsulfone (PPSU, PPSF), vitrimers (covalent adaptable networks CANs) and the like or combinations thereof. In some embodiments, insert film layer 16 can be a functionally active insert layer that is different from the material of the polymer or polymer composite part 14. In some embodiments, insert film layer 16 can be a few nanometers, few microns, or few millimeters in thickness. In some embodiments, insert film layer 16 can be in any form such as but not limited to thin film (solid or flexible) either in millimeter or micron thick, powder form, spray form (aerosol form), nanorods, nanoparticles, nano-films, and the like and in combinations thereof. However, it should be appreciated that insert film layer 16 is not anticipated to be in adhesive glue form of any kind. In some embodiments, insert film layer 16 can be in fiber filled prepreg form and/or wherein the base polymer material is thermoplastic polymer and fibers can be of any form (continuous, small, long, chopped, spherical, etc.) or type (glass, carbon, aramid, natural, etc.) in the prepreg. In some embodiments, the insert film layer 16 can be made of fiber filled or unfilled vitrimer reinforcement materials. In some embodiments, reinforcement material is selected from the group consisting of natural fibers, glass fibers, carbon fibers, glass or silica particles. In some embodiments, the insert layer material can be mixed in-situ or ex-situ with the base polymer/polymer composite material to make it a mixture.

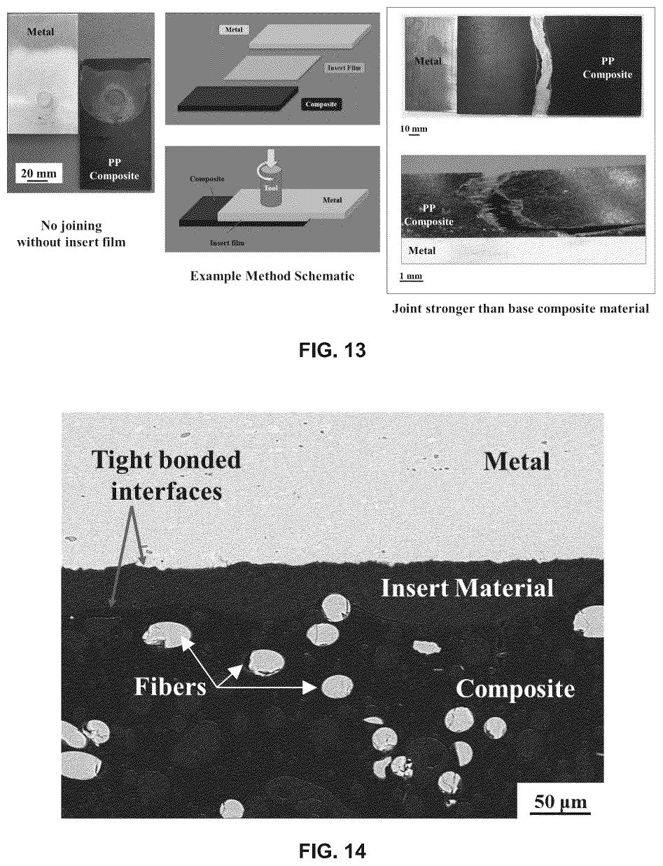

In accordance with the present teachings, a method is provided wherein insert film layer 16 made of a polymer and/or polymer composite is inserted between metal part 12 and polymer part 14. The method further includes heating metal part 12 using a heating source or system 102, while simultaneously applying and maintaining the assembly (i.e., metal part 12, polymer part 14, and insert film layer 16) under sufficient pressure by actuating a forge force system 106 to maintain intimate contact between metal part 12, polymer/polymer-composite part 14, and insert film layer 16. That is, in some embodiments, joining takes place by keeping metal part 12, polymer part 14, and insert film layer 16 under said pressure and heating the metal side (i.e., the metal part 12) sufficiently to reach melting point of both the polymer part 14, and insert film layer 16 but not too high to avoid the polymer flash point and metal melting temperature. The molten polymers of polymer part 14 and insert film layer 16 mix together by physical intermingling (see FIGS. 12 and 14) and/or chemical reaction among available polymer molecules. In case of polymer composites, molten polymers form an intermixed polymer composite at the interface 18 (see FIGS. 12 and 14). Overall, making a sufficient volume of polymer melt pool to react chemically/atomically and join intimately with metal surface of the metal part 12 (see FIGS. 12-15).

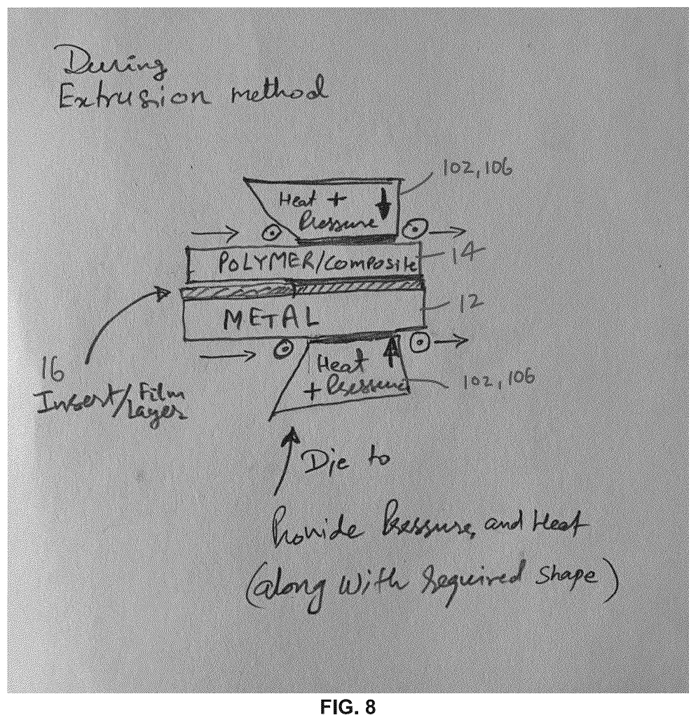

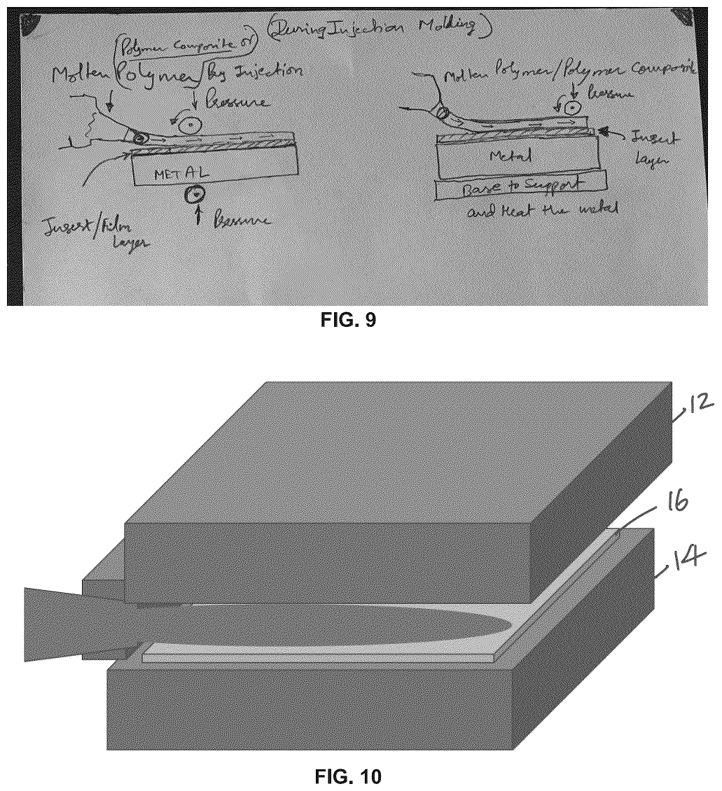

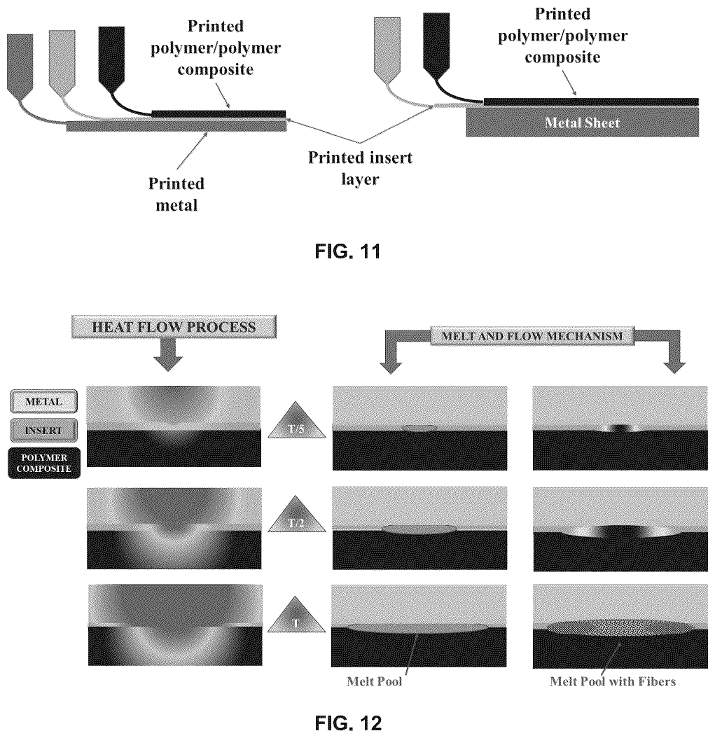

In some embodiments, heating source or system 102 can comprise any heating source, such as external, internal, direct, indirect, derived, or any combination thereof. That is, heating source 102 can be applied from an external side on the metal part 12, physically touching or from far away; from an internal side of the metal part 12, using the molten pool of polymer or by any other combination as well. Heating source or system 102 can comprise laser heating, frictional heating (such as but not limited to, friction spot (see FIG. 5-7), friction lap, friction stir), fusion (such as but not limited to 3D printers) (see FIG. 11), hot water treatment heating, ultrasonic heating, injection mold type heating (see FIG. 9-10), induction heating, thermal heating, electric resistance heating, laser heating, high energy beam heating, high-rate plastic deformation heating, extrusion heating (see FIG. 8), extrusion molding, plastic molding, or the like and combinations thereof.

In some embodiments, forge force system 106 can provide sufficient pressure to maintain intimate contact between metal part 12, polymer part 14, and insert film layer 16. Forge force system 106 can comprise any type of system such as but not limited to hydraulic, mechanical, electro-mechanical, servo-electronic actuators, or the like and combinations thereof. In some embodiments, heating source 102 and forge force system 106 can be an integrated system. In some embodiments, the compression force exerted by forge force system 106 can be applied perpendicular to the joint interface. A back support can be provided to oppose this compression force.

Accordingly, it should be understood that the method of the present teachings provides direct joining of metal and hard-to-weld polymer/polymer composite materials to manufacture and/or provide cost-efficient metal-polymer hybrid structures for structural light-weighting applications. Significant cost savings as no requirement of any sort of surface treatment on metal or composite side is required. The present method also provides capability of mass production due to simplified processing.

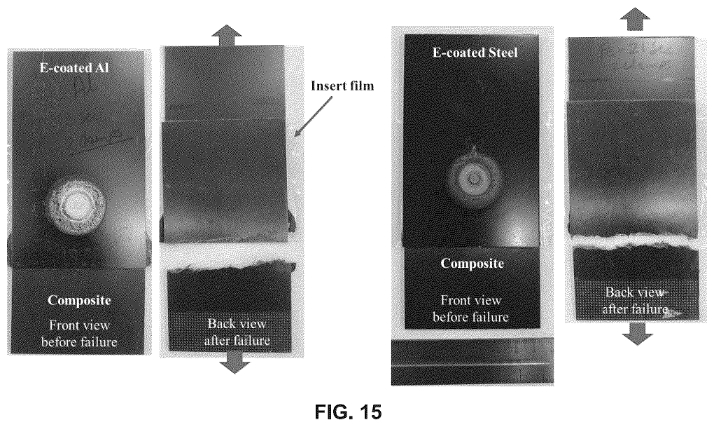

Moreover, the present teachings enable joining by chemical bonding with metal and not by mechanical interlocking (anchoring) and provide capability to join coated/uncoated metal with polyolefin thermoplastic polymer/polymer composites. The present teachings do not require any sort of special surface/bulk treatment on the metal or polymer/polymer composite side and provide capability to join coated (corrosion protection layer such as epoxy by e-coating etc.) (see FIG. 15) or uncoated metal with polymer/polymer composite materials.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of joining a metal part and a polymer/polymer composite part, the method comprising:
providing a metal part;
providing a polymer or polymer composite part;
inserting an insert layer between the metal part and the polymer or polymer composite part; and
applying heat to the metal part to a temperature above the melting temperatures and below a degradation temperature of the polymer or polymer composite part and the insert layer and simultaneously applying pressure to the combination of the metal part, the polymer or polymer composite part, and the insert layer to combine the metal part and the polymer or polymer composite part into a joined assembly having a chemical bond therebetween.

2. The method according to claim 1, further comprising:
degreasing a joining surface of the metal part using a non-caustic chemical without changing the surface roughness of the joining surface of the metal part.

3. The method according to claim 2 wherein the non-caustic chemical is ethanol or acetone.

4. The method according to claim 2 wherein the non-caustic chemical is a surface degreasing non-caustic agent.

5. The method according to claim 2 wherein the metal part has a surface roughness less than Ra 0.76 microns (μm).

6. The method according to claim 1 wherein the insert layer is a functionally active polymer material layer.

7. The method according to claim 1 wherein the insert layer is a composite material layer having a functionally active polymer as its base material matrix.

8. The method according to claim 1 wherein the insert layer comprises. a reinforcement.

9. The method according to claim 8 wherein the reinforcement is selected from the group consisting of natural fibers or particles, glass fibers or particles, carbon fibers or particles, glass or silica particles.

10. The method according to claim 1 wherein the insert layer has a thickness in the range of 1 nanometer (nm) or more and 6 millimeter (mm) or less at the joining portion between the surface of the metal part and the surface of the polymer or polymer composite layer/part.

11. The method according to claim 1, wherein the step of providing a polymer or polymer composite part comprises injection molding wherein molten polymer or polymer composite is laid upon the metal part and the insert layer is laid therebetween.

12. The method according to claim 1, wherein the step of providing a polymer or polymer composite part comprises extrusion wherein molten polymer or polymer composite is laid upon the metal part and the insert layer is laid therebetween.
